(19) United States
(12) Patent Application Publication
(10) Pub. No.: US 2012/0137211 A1
(43) Pub. Date: May 31, 2012

(54) Method and Apparatus for Specifying Mapping Parameters for User Interface Element Presentation in an Application

(75) Inventor: Stephen Paul Lewontin, Cambridge, MA (US)

(73) Assignee: NOKIA CORPORATION, Espoo (FI)

(21) Appl. No.: 13/116,811

(22) Filed: May 26, 2011

Related U.S. Application Data
(60) Provisional application No. 61/348,473, filed on May 26, 2010.

(51) Int. Cl. G06F 17/00

(52) U.S. Cl. 715/236; 715/234

(57) ABSTRACT

A method and apparatus are provided that may enable the specifying mapping parameters for user interface element presentation in an application. In this regard, for example, a user interface element layout for a native application may be specified by augmenting the source markup for the user interface. Accordingly, for example, native application user interface elements may be generated based on descriptions provided from a web page source with modifications to visual characteristics, initial mappings, state information, and transforms relating to the native application user interface elements being provided by augmenting standard markup.

### RELATED APPLICATION

This application claims priority to U.S. Application No. 61/348,473 filed May 26, 2010, which is incorporated herein by reference in its entirety.

### TECHNOLOGICAL FIELD

Embodiments of the present invention relate generally to user interface technology and, more particularly, relate to an apparatus and method for specifying mapping parameters for user interface element presentation in an application.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of electronic devices and by improving network performance. One area in which there is a demand to increase ease of information transfer relates to the delivery of services to a user of an electronic device. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. Alternatively, the network device may respond to commands or requests made by the user (e.g., content searching, mapping or routing services, etc.). The services may be provided from a network server or other network device, or even from a mobile terminal such as, for example, a mobile telephone, a mobile navigation system, a mobile computer, a mobile television, a mobile gaming system, etc.

User interfaces (UIs) associated with various applications and/or services (e.g., web services) may be accessible via mobile terminals (or other perhaps fixed communication devices) and may be provided, in some cases, via a layout or rendering engine that utilizes marked up content for the generation of displayable formatted elements. User interfaces for native applications (e.g., applications written and compiled to run as a native executable) are typically generated using proprietary markup languages that may require special-purpose proprietary generation tools and libraries. Meanwhile, non-proprietary markup languages (e.g., like HTML (hypertext markup language) may be fairly standard and widely available, but limited to usage in generating user interfaces for web applications (e.g., applications written in HTML, JavaScript or cascading style sheets (CSS) in order to run in a web rendering environment such as a browser or widget engine) and web widgets.

Web application user interfaces are often inefficient at performing certain tasks (e.g., media playing) that require highly-tuned, platform specific native code. Web environments therefore often support platform native plugins that run as controls within a browsing user interface window. Web applications are also typically forced to mix content presentation with user interface controls. The limitations associated with non-proprietary markup languages used for web application user interfaces and the proprietary nature of markup languages used to generate native application user interfaces can cause inefficiency and unnecessary complexity in relation to generating user interfaces for a variety of different applications and services.

Accordingly, it may be desirable to provide an improved mechanism for user interface generation and customization.

### BRIEF SUMMARY OF EXAMPLE EMBODIMENTS

A method and apparatus are therefore provided that may enable the specifying mapping parameters for user interface element presentation in an application. In this regard, for example, a user interface element layout for a native application may be specified by augmenting the source markup for the user interface. Accordingly, for example, native application user interface elements may be generated based on descriptions provided from a web page source with modifications to visual characteristics, initial mappings, state information, and transforms relating to the native application user interface elements being provided by augmenting standard markup.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for enabling specifying a runtime layout in an application according to an example embodiment of the present invention;

FIG. 3 illustrates an example operation of a user interface web engine according to one embodiment;

FIG. 4 illustrates an example operation of the user interface web engine according to another embodiment;

FIG. 5 illustrates an example operation of the user interface web engine according to yet another embodiment;

FIG. 6 illustrates an example operation of the user interface web engine according to still another embodiment; and

FIG. 7 illustrates a flowchart of a method of enabling specifying a runtime layout in an application in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Mobile terminals and other electronic computing and/or communication devices are becoming very common and very personal to their respective users. As such, the user interface options offered by these devices should be appealing to the users. Moreover, in a world where users can relatively cheaply and easily shift from one application (or event device) to another simply because they enjoy one user interface offered on one platform more than another it is a powerful incentive to provide robust user interfaces to users. However, as indicated above, generation of user interfaces can be complicated by the fact that the generation of user interfaces for native applications using declarative markup languages (e.g., a markup language based on a logical document model that describes the logical structure of a document independent of its physical representation) typically requires the use of proprietary markup languages. However, non-proprietary markup languages like HTML typically have not been used as a declarative markup for native application user interface generation. Instead, HTML has been used in relatively limited ways as a customization mechanism.

Some embodiments of the present invention may, however, provide a mechanism to generate multiple, independent user interface elements for a native application from a source page (or pages) containing standard web content (e.g., HTML, CSS or JavaScript). Thus, for example, individual elements of the web page (e.g., HTML elements) may be mapped to individual native application user interface elements to enable visual representation and user interaction with the generated native user interface elements. Accordingly, web page contents may provide layout within a user interface element, appearance, and behavior criteria for user interface elements of a native application. As such, some embodiments may therefore provide for an ability to adapt non-proprietary markup languages (e.g., like HTML, CSS, JavaScript and/or the like) for use as a declarative markup for native application user interface generation.

Some embodiments may further provide for an ability to specify the layout of user interface elements that are generated. For example, user interface element layout may be specified by augmenting the source markup for the user interface. As such, the runtime layout and other visual properties of, for example, HTML-generated user interface elements may be specified by augmenting standard markup.

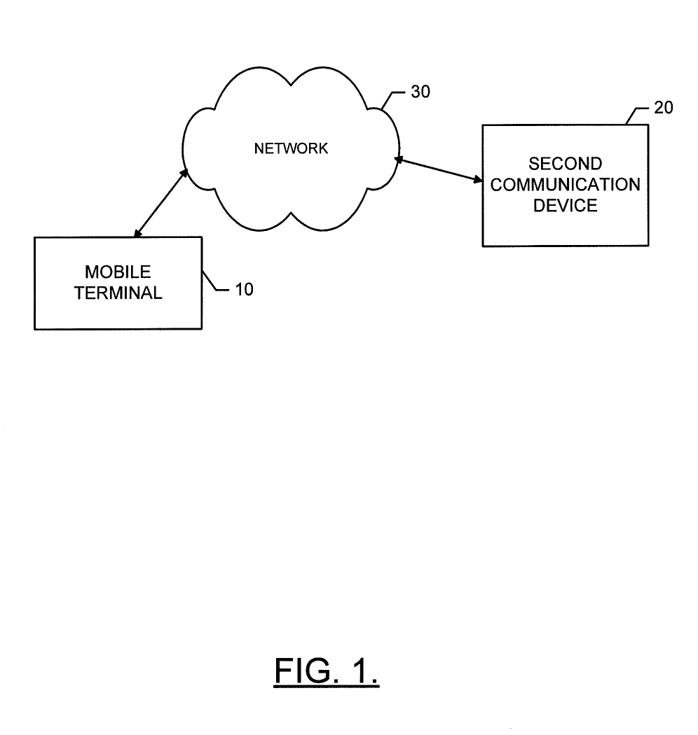

FIG. 1 illustrates a generic system diagram in which a device such as a mobile terminal 10, which may benefit from embodiments of the present invention, is shown in an example communication environment. As shown in FIG. 1, an embodiment of a system in accordance with an example embodiment of the present invention may include a first communication device (e.g., mobile terminal 10) and a second communication device 20 capable of communication with each other. In an example embodiment, the mobile terminal 10 and the second communication device 20 may be in communication with each other via a network 30. In some cases, embodiments of the present invention may further include one or more network devices with which the mobile terminal 10 and/or the second communication device 20 may communicate to provide, request and/or receive information.

It should be noted that although FIG. 1 shows a communication environment that may support client/server application execution, in some embodiments, the mobile terminal 10 and/or the second communication device 20 may employ embodiments of the present invention without any network communication. As such, for example, embodiments of the present invention may be practiced with respect to applications executed locally at the mobile terminal 10 and/or the second communication device 20. However, in some alternative cases, embodiments may be practiced with respect to content served to the mobile terminal 10 and/or the second communication device 20 via a wired or wireless link to another device acting as a server.

The network 30, if employed, may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. One or more communication terminals such as the mobile terminal 10 and the second communication device 20 may be in communication with the network 30 or even with each other via the network 30 or via device to device (D2D) communication and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices (e.g., personal computers, server computers or the like) may be coupled to the mobile terminal 10 and/or the second communication device 20 via the network 30. By directly or indirectly connecting the mobile terminal 10 and/or the second communication device 20 and other devices to the network 30 or to each other, the mobile terminal 10 and/or the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not specifically shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, the first communication device (e.g., the mobile terminal 10) may be a mobile communication device such as, for example, a PDA, wireless telephone, mobile computing device, camera, video recorder, audio/video player, positioning device (e.g., a GPS device), game device, television device, radio device, or various other like devices or combinations thereof. The second communication device 20 may also be a mobile device such as those listed above or other mobile or embedded devices, but could also be a fixed communication device (e.g., a personal computer (PC) or a network access terminal) in some instances.

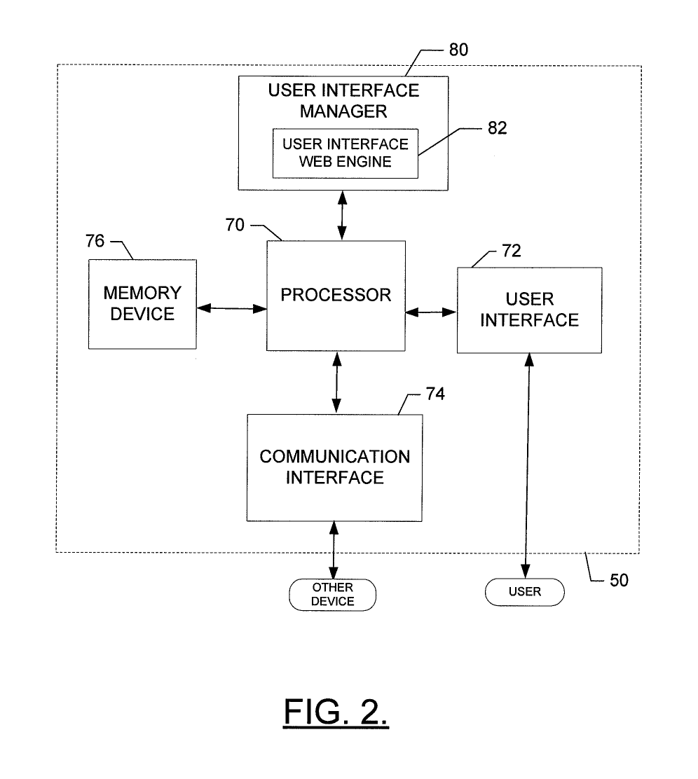

In an example embodiment, the mobile terminal 10 (and/or the second communication device 20 or some other network device) may be configured to include or otherwise employ an apparatus according to an example embodiment of the present invention. FIG. 2 illustrates a schematic block diagram of an apparatus for providing generation of multiple independent user interface elements from a web page according to an example embodiment of the present invention. An example embodiment of the invention will now be described with reference to FIG. 2, in which certain elements of an apparatus 50 for providing generation of multiple independent user interface elements from a web page are displayed. The apparatus 50 of FIG. 2 may be employed, for example, on a communication device (e.g., the mobile terminal 10 and/or the second communication device 20) or a variety of other devices, such as, for example, any of the devices listed above when such devices are acting as a server device. However, it should be noted that the components, devices or elements described below may not be mandatory and thus some may be omitted in certain embodiments. Additionally, some embodiments may include further components, devices or elements beyond those shown and described herein.

Referring now to FIG. 2, the apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, processing circuitry, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., the mobile terminal 10 or the second communication device 20) adapted for employing embodiments of the present invention by further configuration of the processor 70 by instructions for performing the algorithms and/or operations described herein. By executing the instructions or programming provided thereto or associated with the configuration of the processor 70, the processor 70 may cause corresponding functionality to be performed. The processor 70 may include, among other things, a clock, an arithmetic logic unit (ALU) and logic gates configured to support operation of the processor 70.

Meanwhile, the communication interface 74 may be any means such as a device or circuitry embodied in either hardware, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10 or the second communication device 20), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control a user interface manager 80. As such, in some embodiments, the processor 70 may be said to cause, direct or control the execution or occurrence of the various functions attributed to the user interface manager 80 as described herein. The user interface manager 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the user interface manager 80 as described herein. Thus, in examples in which software is employed, a device or circuitry (e.g., the processor 70 in one example) executing the software forms the structure associated with such means.

In an example embodiment, the user interface manager 80 may be configured to act as or otherwise operate a user interface web engine 82. The user interface web engine 82 may be software configured to act as a layout or rendering engine for using marked up content and formatting information to provide formatted content for display (e.g., to a display of the user interface 72). As such, the user interface manager 80 (e.g., via the processor 70) may be responsible for causing the functionality described herein in reference to the user interface web engine 82.

The user interface web engine 82 may be configured to generate a native application user interface from non-proprietary markup such as HTML, CCS, JavaScript and/or the like. As such, the user interface web engine 82 may be configured to generate multiple independent user interface elements for a native application using a web page (e.g., comprising standard web content including HTML, CSS, JavaScript, etc.) as a source. In other words, while a typical web page renders all of the elements therein within a single user interface window, the user interface web engine 82 may be configured to generate elements into multiple separate controls that may be displayed, interacted with, and otherwise manipulated independently of each other. As such, the user interface web engine 82 of example embodiments may be configured to use a non-proprietary markup as a declarative markup for native application user interface generation.

In an example embodiment, the user interface web engine 82 may be configured to receive source data comprising one or more web pages with corresponding standard web content (e.g., HTML, CSS, JavaScript, etc.). The user interface web engine 82 may also be configured to map individual elements of the source data to corresponding native application user interface elements. The elements may include toolbars, buttons, control consoles, and other visually displayable features that have corresponding control functionalities associated therewith. As such, the source data (e.g., in the form of a web page) may declare the layout within a user interface element, appearance and behavior of native application user interface elements. In this regard, the user interface web engine 82 may be configured to provide a mapping to enable visual rendering of user interface elements and also enable user interaction with the rendered elements. Thus, for example, the user interface web engine 82 may provide a mapping or translation from source data user interface elements to native application user interface elements that enables visual rendering and control functionality prescribed in the source data to be declared for the native application.

In an example embodiment, the contents of individual source data elements (e.g., HTML elements or elements associated with CSS, JavaScript, etc.) may be visually rendered as corresponding separate user interface controls of the native application. Additionally, the user interaction with specific user interface controls (e.g., via mouse, keyboard, touch screen, etc.) is mapped to a corresponding element in the source data. Thus, for example, if the user touches a particular user interface control area that represents a button displayed on a touch screen, the touch event may be forwarded to the corresponding element in the source data web page. By providing the mapping or translation, the web page is able to interact with (or respond to) the user input events in a normal way as if the user were interacting directly with the underlying web page (e.g., by invoking a JavaScript method to redraw a button represented in the pushed state). In addition, by providing the translation or mapping, the possibility is opened for enhancing or modifying the presentation and/or interaction. In other words, the mapping may not necessarily directly render a specific user interface element on the native application with the exact same appearance, location and/or functionality that was associated with the corresponding mapped source data user interface element. The rendering of the native application user interface element may be modified (e.g., in terms of appearance and/or location) and the functionality of the native application user interface element may be modified by the mapping provided by the user interface web engine 82. In some embodiments, the mapping could be a one-to-one (or, possibly one-to-many) correspondence between HTML elements and UI elements, a set of visual transformations such as affine transforms (e.g., scaling, translation, rotation, etc.) and rendering effects (such as fading, transparency, etc.), translations of user interface events (corresponding to any affine transforms), state mappings whereby elements may be marked as enabled, disabled, active, etc., and/or the like. States may have corresponding visual representations, but states may also refer to functionality.

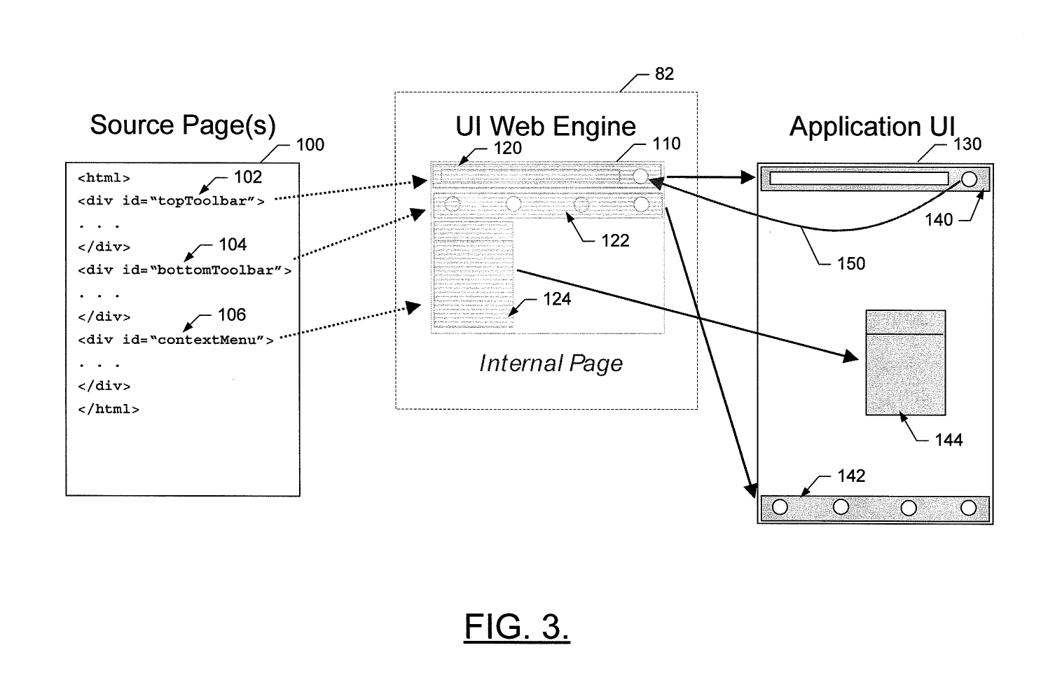

FIG. 3 illustrates an example operation of the user interface web engine 82 according to one embodiment. In this regard, FIG. 3 illustrates a source web page 100 that defines various source data user interface elements, which are HTML elements in this example. The source data user interface elements of this example include element 102 defining a top toolbar, element 104 defining a bottom toolbar, and element 106 defining a context menu. The source web page 100 may be provided to the user interface web engine 82 as source data. The source web page 100 may be included in a single web page file or in multiple web page files. The markup may include markup and markup extensions that are associated with any markup suitable for running in a web rendering environment.

FIG. 3 illustrates a UI internal page 110 indicating an internally laid-out and processed representation of the user interface of the web-based source data. However, it should be appreciated that the UI internal page 110 is not visually rendered as a whole page by the application, but is instead shown to help to illustrate the effect of the mapping provided by the user interface web engine 82. As shown in FIG. 3, the UI internal page 110 may include a top toolbar 120, a bottom toolbar 122 and a context menu 124 (that correspond to the respective elements 102, 104 and 106). The user interface web engine 82 may then map the respective elements from the source data (e.g., elements 102, 104 and 106) to corresponding user interface elements of a native application user interface 130 including a top toolbar 140, a bottom toolbar 142 and a context menu 144. The native application user interface 130 typically manages user interface controls via the mechanisms of the platform native environment. However, the native application user interface 130 of example embodiments, interacts with the user interface web engine 82 to instantiate, render and handle events for user interface controls based on the mapping of the user interface web engine 82. As such, for example, the native application user interface 130 may determine the layout and visual behavior of user interface controls independently of the user interface web engine 82 although the native application user interface 130 may rely on the user interface web engine 82 for element rendering.

In an example embodiment, the user interface web engine 82 may support standard web content loading, layout and rendering of HTML, CSS, JavaScript and/or the like, and may be based on an existing web engine, but perhaps with various extensions. In some cases, when the user interface web engine 82 processes a source page, the user interface web engine 82 may create (or have the native application user interface 130 create) native user interface controls corresponding to specific elements in the source page. Typically these controls correspond to block-level elements in the source (such as the <div> elements shown in the source web page 100 of FIG. 3) but such correspondence is not required. The markup of the source web page 100 may include attributes (for example, HTML class or id attributes), that identify user interface elements to the user interface web engine 82, although it may also be possible to implement embodiments such that the user interface elements are identified in some other way.

The user interface web engine 82 may be configured to act as if it were laying out the source web page 100 normally (e.g., as in the UI internal page 110), although no actual visual rendering of the laid-out source page may be provided. The dotted lines in FIG. 3 illustrate correspondence between the elements 102, 104 and 106 and respective elements of the UI internal page 110 (e.g., elements 120, 122 and 124). In some cases, the correspondence between elements in the source markup and the UI internal page 110 may be determined by normal HTML layout rules for defining the layout within a user interface element (e.g., the size of elements and their internal layout).

For each user interface element of the source web page 100 (e.g., elements 102, 104 and 106), the user interface web engine 82 may record an object (e.g., an element rectangle) occupied by the corresponding element in the UI internal page 110. The user interface web engine 82 may then provide or generate a set of mappings between elements in respective different user interfaces (e.g., the original web source and the native application user interface) by mapping rectangles (or other shapes) corresponding to the markup of the source web page 100 and corresponding rectangles (or other shapes) of the native user interface controls as instantiated by the native application user interface 130. As shown in FIG. 3, the locations of the native user interface controls in the native application user interface 130 may not necessarily correspond to the locations of the corresponding element rectangles. The native application user interface 130 may therefore perform transforms or modifications on the element rectangles (e.g., such as scaling and rotating native user interface elements). The native application user interface 130 (e.g., via the user interface web engine 82 mappings) may perform transformations statically (e.g., by altering location or size of an element) or dynamically (e.g., by supporting animated transitions of user interface elements). The mappings of corresponding rectangles that are maintained by the user interface web engine 82 may record the current state of the transformations between element rectangles and the corresponding native user interface control rectangles.

In some embodiments, the user interface web engine 82 may visually render the source elements to the corresponding native user interface controls, for example, by painting the source elements on the UI control surfaces. As such, for example, the user interface web engine 82 may use the stored rectangle mappings to affect any transforms required by the rendering. These mapped renderings are indicated by the solid lines between elements of the UI internal page 110 (e.g., elements 120, 122 and 124) and their corresponding elements of the native application user interface 130 (e.g., elements 140, 142 and 144).

In some examples, the user interface web engine 82 may use the stored rectangle mappings to map user interface events for native user interface elements back to the corresponding locations in the source web page. Mapped events include user touch events, mouse events, focus events, key presses, and any other events generated as a result of interaction with the native user interface controls. The result may be, for example, that the HTML elements of the UI internal page 110 handle user interface events on behalf of their corresponding native user interface controls. As an example, if a button push (indicated by arrow 150) is received relative to the top toolbar 140 of FIG. 3, the occurrence of the event may be communicated back through the user interface web engine 82 to initiate processing by the user interface web engine 82 in the way defined for the corresponding event according to the markup provided for the source web page 100. Thus, for example, events such as link activation and other user interface events, form actions, and invoked actions such as JavaScript handlers and/or other actions may be processed. In addition, the user interface web engine 82 may also provide additional handling mechanisms to support efficient interaction with application native code.

In some embodiments, the source markup may define user interface elements via vertically laid-out block-level elements with defined element heights in order to allow the user interface web engine 82 to efficiently calculate any needed element rectangles. In some cases, default sizes of user interface controls (before any transformations) may be determined by the corresponding element rectangles in the UI internal page 110. In some embodiments, the user interface web engine 82 may be configured to make use of additional markup in the source data to determine an initial layout and visibility of user interface elements by the native application user interface 130. Furthermore, the user interface web engine 82 may be configured to support a mix of native and web-rendered user interface elements.

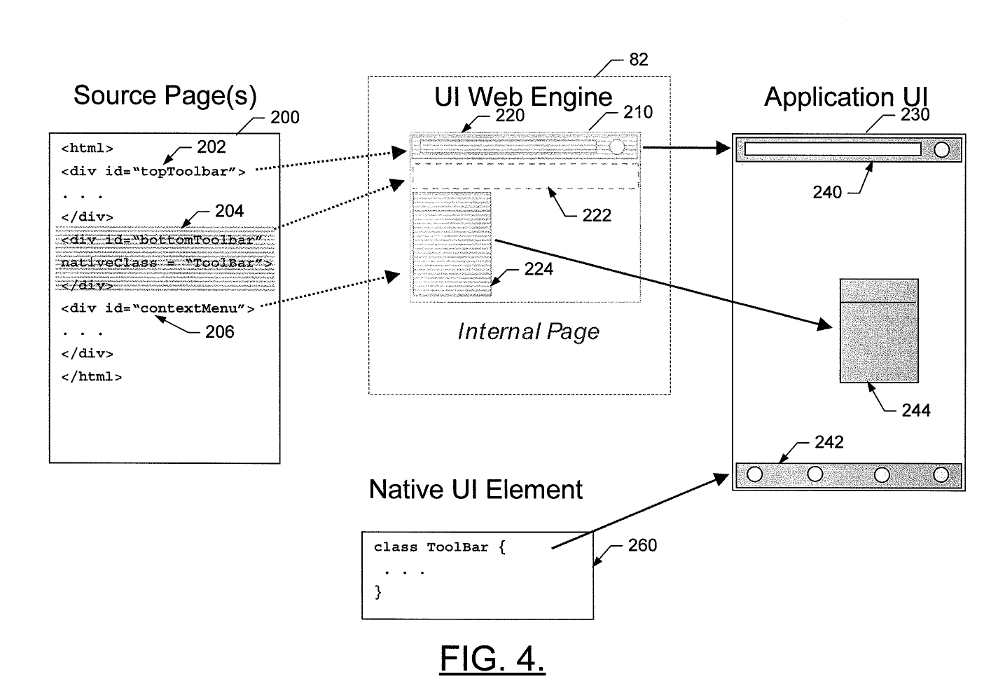

FIG. 4 illustrates an example operation of the user interface web engine 82 according to one embodiment. In this regard, the embodiment of FIG. 4 describes operation of the user interface web engine 82 with respect to combining native user interface elements rendered from web page contents (e.g., rendered based on source data from the source web page 100) with pure native-rendered user interface elements in an application user interface. In other words, some elements rendered at the native application user interface 130 may be rendered from corresponding elements of the source web page 100, while other elements are rendered using only native graphics operations for the application's development environment (referred to herein as “pure native-rendered UI elements”).

In the example embodiment of FIG. 4, as described above in reference to FIG. 3, a source web page 200, which may be included in a single web page file or in multiple web page files, may define various source data user interface elements, which are HTML elements in this example. The source data user interface elements of this example include element 202 defining a top toolbar, element 204 defining a bottom toolbar, and element 206 defining a context menu. The source web page 200 may be provided to the user interface web engine 82 as source data. The user interface web engine 82 may process the content of the source page to generate user interface elements represented by a UI internal page 210 that is not actually visually presented, but indicates an internally laid-out and processed representation of the user interface of the web-based source data. The UI internal page 210 may include elements that correspond to respective elements of the source web page 200. The dotted lines in FIG. 4 illustrate correspondence between the elements 202 and 206 of the source web page 200 to respective elements of the UI internal page 210 (e.g., elements 220 (a top toolbar) and 224 (a context menu)). These elements may then be mapped to corresponding elements (e.g., elements 240 (a top toolbar) and 244 (a context menu) of a native application user interface 230 (as indicated by the solid lines from the UI internal page 210 to the native application user interface 230). In this example embodiment, native- and HTML-rendered user interface elements may both be declared in the HTML source markup.

In an example embodiment, some (or perhaps each) of the native-rendered elements may be marked to identify the native code module (or modules) used to instantiate the corresponding user interface element. For example, a native code module can be identified by a class name, a shared library name, or in some other way. A native-rendered element need not have any HTML content. For example, a native-rendered element can be represented in the source as empty block-level element such as <div> tag. However, such an element may also contain HTML content that can be used as an alternative rendering for the element, for example, in the case that the native module cannot be instantiated. When the user interface web engine 82 processes the source page, it instantiates the native-rendered elements from the code modules identified in the markup. The user interface web engine 82 may be configured to use a variety of methods for instantiating named modules such as, for example, if the code module is identified by a class name, the user interface web engine 82 may be configured to create an instance of the named class. As another example, if the code module is identified by a shared library name, the user interface web engine 82 may be configured to load the library and call a pre-defined entry-point, etc. Thus, as shown in FIG. 4, although element 204 corresponds to a bottom toolbar, the element corresponding to the bottom toolbar (e.g., element 242) of the native application user interface 230 may be generated from a native user interface element 260 defining a bottom toolbar.

Although this example embodiment illustrates a case in which a mix of native and source data rendered user interface components is provided, it should be appreciated that the native rendered user interface components may sometimes be modified based on source data. For example, although element 204 of the source web page 200 defines HTML content for a bottom tool bar, the bottom tool bar (element 242) of the native application user interface 230 may be generated based on the native user interface element 260 with modification based on source markup. As a further example, in some embodiments, the source markup may determines the size of each native rendered element as with any other web page element, for example by supplying height and width style rules. As such, a native-rendered element may be defined to occupy a rectangle in the internal page corresponding to its size, as shown by the dotted rectangle 222 in FIG. 4. The dotted rectangle 222 may be empty or may include alternative HTML content. The user interface web engine 82 may therefore be configured to use the element rectangle to size the corresponding native-rendered element (e.g., element 242).

In some embodiments, the user interface web engine 82 may be configured to style a native-rendered element based on CSS style sheets and styling rules as well as other style-related markups. For example, the element border can be specified via CSS border style rules. Each native-rendered element may be given access to the internal HTML page to allow the corresponding native-rendered element to access scripts that are part of the source data. For example, an element representing a button can invoke a JavaScript button press handler. Native-rendered elements can also be scripted via the same scripting interfaces used to script HTML-rendered user interface elements. For example, a JavaScript interface used to animate user interface elements may be applied both to native- and HTML-rendered elements. While native-rendered elements can access and be scripted by the source data, native-rendered elements are in no way limited to interaction with the application via scripting interfaces. Native-rendered elements can also interact with the application directly via pure native code paths. By allowing a mix of native- and HTML-rendered UI elements, some example embodiments may overcome potential performance limitations of a user interface where all elements are HTML-rendered. Accordingly, provision may be made to allow performance-critical UI elements to be coded by the most efficient code path while keeping web-based declarative markup, style and scripting.

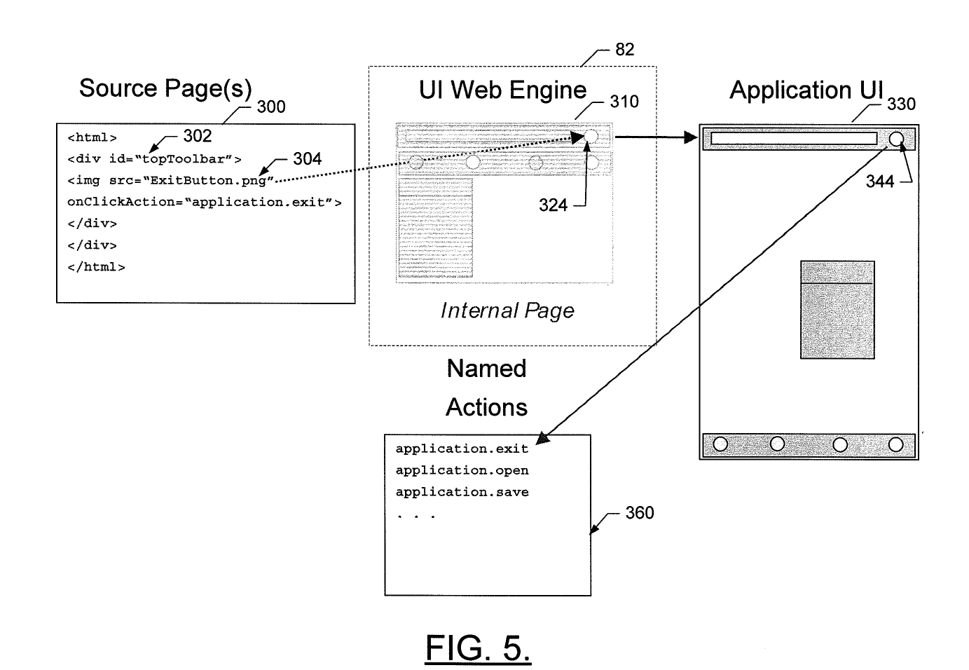

FIG. 5 illustrates an example operation of the user interface web engine 82 according to another embodiment. In this regard, the embodiment of FIG. 5 describes operation of the user interface web engine 82 with respect to enabling user interface elements to directly interact with the application via native code invocation without invoking a scripting engine. In this mechanism, named application actions are specified within the user interface source markup, and the user interface web engine 82 routes native user interface events directly to the corresponding native action handlers.

In the example embodiment of FIG. 5, similar to the descriptions above for FIGS. 3 and 4, a source web page 300, which may be included in a single web page file or in multiple web page files, may define various source data user interface elements, which are HTML elements in this example (but alternatively could be JavaScript, CSS or other elements). The source data user interface elements of this example include element 302 defining a top toolbar and element 304 defining a button on the top toolbar. The source web page 300 may be provided to the user interface web engine 82 as source data. The user interface web engine 82 may process the content of the source page to generate user interface elements represented by a UI internal page 310 that is not actually visually presented, but indicates an internally laid-out and processed representation of the user interface of the web-based source data. The UI internal page 310 may include elements that correspond to respective elements of the source web page 300. The dotted line in FIG. 5 illustrates correspondence between the elements 304 and the button 324 of the UI internal page 310. The button 324 may then be mapped (along with the top toolbar) to a corresponding button 344 of a native application user interface 330 (as indicated by the solid lines from the UI internal page 310 to the native application user interface 330).

In an example embodiment, the native application may specify a set of named actions 360 that may be invoked from user interface elements. Event handlers specified in the source web page 300 markup may refer to these named actions instead of script expressions. The user interface web engine 82 may be configured to be extended to support this in a number of possible ways. As an example, the user interface web engine 82 may be configured to support extended event attributes on HTML elements with values that name actions rather than containing script expressions. For example, the engine could support an onclickaction attribute. The user interface web engine 82 may be configured to modify processing of existing event attributes (for example, onclick) so that the attribute values can be either named actions or script expressions. For example, the user interface web engine 82 may be configured to intercept the processing of these attributes to discover whether they refer to named actions or contain script expressions.

In some embodiments, when the user interface web engine 82 processes an element in the source document that specifies a native event action, the user interface web engine 82 may create a native action handler for the specified event on the native UI element. For example, when processing an onclick attribute that specifies a native action handler, the user interface web engine 82 may create a native event handler equivalent to onclick and connect it directly to the native handler.

In some embodiments, when a user interface event occurs on an element that specifies an extended action handler, the native user interface element may process this event directly via the platform native event handling mechanism without having to invoke HTML event processing or the script engine. In addition, the user interface web engine 82 may be configured to allow elements to specify both native actions and script handlers for the same event. The user interface web engine 82 may then route event processing both to the native action and to HTML event handling. This, for example, may enable a scenario where a button first invokes a native action and then invokes an HTML animation of the button appearance. This would allow both for an efficient native action invocation and HTML visual rendering of the “button pressed” state, etc. By allowing HTML-rendered elements to specify native actions, performance critical actions may be performed without invoking HTML event or script engine processing. This may make it possible to overcome possible performance costs associated with an HTML rendered user interface.

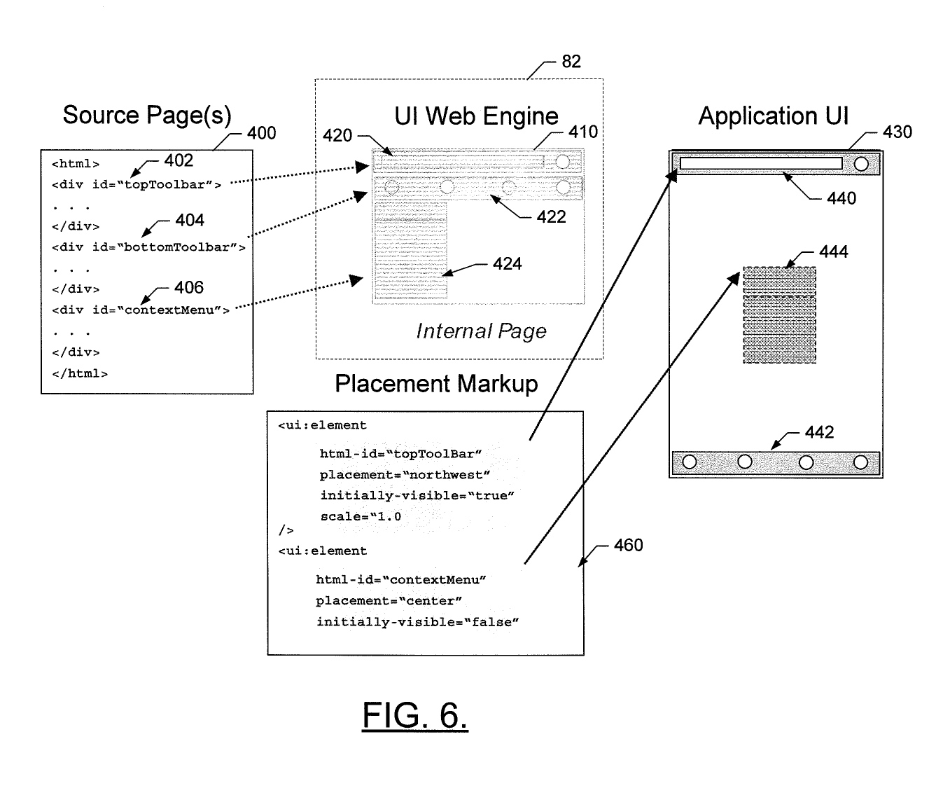

As described above, HTML markup, CSS style sheets, and JavaScript can be used to specify native user interface elements for an application. Using this mechanism, the appearance of user interface elements in the native application may correspond to the appearance of the user interface elements in the source document, but their placement in the application user interface may not generally correspond to their placement in the source document (e.g., as laid-out by an HTML or scripting engine). FIG. 6 illustrates an example in which the placement of user interface elements in the internal page does not correspond to the placement of the user interface elements in the native application user interface. In addition, other visual characteristics of the user interface elements may not necessarily correspond to the layout of the source document. For example, user interface elements may not always be visible, may be scaled from the specified sizes (e.g., as specified via HTML, CSS, JavaScript, etc.). As such, some embodiments may provide for specifying the behavior, element state and other layout related features such as placement and other visual properties of user interface elements (e.g., initial values that can by dynamically changed during application execution, element state, and other mappings) generated based on source data (e.g., HTML-generated, CSS-generated, or JavaScript-generated user interface elements) when the native application user interface elements are rendered. In some embodiments, the source data may be augmented, for example, by modifying the HTML source markup with additional presentation markup defining information about element state, behavior, placement and visibility. The augmentation may be provided in the form of presentation markup that may include a placement markup used to specify the location, visual transform markup used to specify visibility and/or other rendering parameters (e.g., animation, visual effects, and/or the like), and other types of markup (e.g., behavior related markup or state related markup) for specifying corresponding other features that are to be applied to the native application user interface elements rendered.

In an example embodiment, similar to the descriptions above for FIGS. 3-5 above, a source web page 400, which may be included in a single web page file or in multiple web page files, may define various source data user interface elements, which are HTML elements in this example (but alternatively could be JavaScript, CSS or other elements). The source data user interface elements of this example include element 402 defining a top toolbar, element 404 defining a button on the top toolbar and element 406 defining a context menu. The source web page 400 may be provided to the user interface web engine 82 as source data. The user interface web engine 82 may process the content of the source web page 400 to generate user interface elements represented by a UI internal page 410 that is not actually visually presented, but indicates an internally laid-out and processed representation of the user interface of the web-based source data. The UI internal page 410 may include elements that correspond to respective elements of the source web page 400. The dotted lines in FIG. 6 illustrate correspondence between the various source data user interface elements (e.g., elements 402, 404 and 406) and a top toolbar 420, a bottom toolbar 422 and a context menu 424 of the UI internal page 410. The top toolbar 420, a bottom toolbar 422 and a context menu 424 of the UI internal page 410 may then be mapped to a corresponding top toolbar 440, a bottom toolbar 442 and a context menu 444 of a native application user interface 430 (as indicated by the solid lines from the UI internal page 410 to the native application user interface 430). However, as shown in FIG. 6, presentation markup 460 may be provided to identify visual rendering parameters for modification of the placement, visibility, scaling, style properties and/or the like of the user interface elements rendered on the native application user interface 430. As such, the presentation markup 460 may represent an indication of visual rendering parameters defining a modification for placement, visibility, scaling, style properties and/or the like for user interface elements.

In an example embodiment, additional non-standard presentation markup (as indicated by presentation markup 460 in FIG. 6) may be applied to the user interface elements in the source web page 400. This additional presentation markup may be specified in several ways. For example, the presentation markup may be specified by adding the presentation markup directly to the source data (e.g., to the HTML markup) by adding non-standard attributes or elements. For example, an element that is to be placed at the upper left-hand corner of the application user interface might be marked with an attribute such as ukplacement=“northwest”. As such, the presentation markup may act as metadata descriptive of visual rendering parameters in the source data. In some embodiments, the presentation markup may be specified by adding non-standard CSS style rules. For example, non-standard property declarations such as {ui-placement: northwest;} may be utilized to again place an element in the upper left-hand corner of the native application user interface 430. In some examples, the presentation markup may be specified by providing JavaScript classes that control user interface element placement. For example, the classes may be inserted in the source page JavaScript context. In other examples, the presentation markup may be specified in a separate document that uses non-standard markup to apply placement and visibility properties to standard HTML elements specified in the source web page 400. For example, an XML (extensible markup language) document might specify placement of the HTML element with id “ToolBar” as <ui:element html-id=“ToolBar” placement=“northwest”/> to again provide for place of an element in the upper left-hand corner of the native application user interface 430.

Non-standard markup extensions such as those described above may be applied beforehand by designers using rules or other extensions defined in the presentation markup. However, in some embodiments, the user may perhaps modify code via a wizard that enables the user to provide instructions on placement, visibility, scaling and other non-standard style properties that can be converted into presentation markup. The non-standard markup extensions can therefore be applied to any visual property of specified user interface elements including, for example, placement, visibility, scaling, and non-standard style properties. In some embodiments, the user interface web engine 82 may be extended to process the non-standard markup. As the user interface web engine 82 processes each element, the user interface web engine 82 may parse the non-standard markup and apply the appropriate native operations to the corresponding user interface elements to place them in the native application user interface 430 and set other properties such as visibility, scaling, and visual style according to the presentation markup. As such, in some embodiments, source markup may enable the provision of a complete declarative user interface specification for a native application.

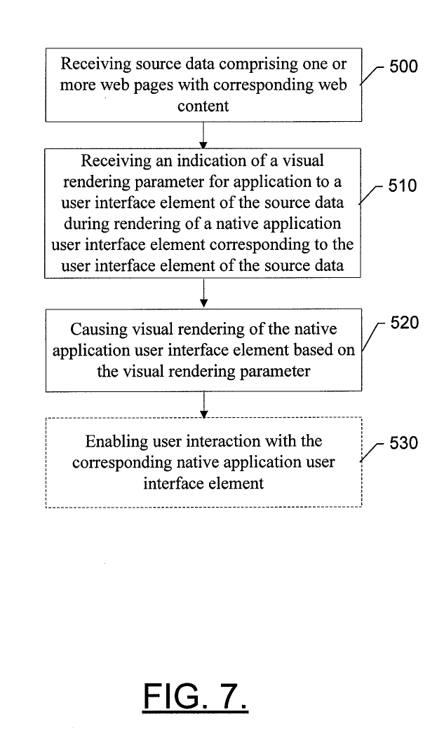

FIG. 7 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method for specifying a runtime layout in an application, as shown in FIG. 7, includes receiving source data comprising one or more web pages with corresponding web content (e.g., generated via HTML, CSS, JavaScript and/or the like) at operation 500, receiving an indication of a visual rendering parameter for application to a user interface element of the source data during rendering of a native application user interface element corresponding to the user interface element of the source data at operation 510 and causing visual rendering of the native application user interface element based on the visual rendering parameter at operation 520.

In some embodiments, certain ones of the operations above may be modified or further amplified as described below. Furthermore, in some embodiments, additional optional operations may be included, an example of which is shown in dashed lines in FIG. 7. Modifications, additions or amplifications to the operations above may be performed in any order and in any combination. In this regard, for example, the method may further include enabling user interaction with the corresponding native application user interface element at operation 530. In an example embodiment, receiving the indication of the visual rendering parameter may include receiving presentation markup defining a modification for placement, visibility, scaling, or style properties of the native application user interface element. In some embodiments, receiving presentation markup may include receiving presentation markup specified directly in the source data, receiving presentation markup specified by adding non-standard cascading style sheet (CSS) style rules, receiving presentation markup specified by providing a JavaScript class that controls user interface element placement, or receiving presentation markup specified in a separate document that uses non-standard markup to apply placement and visibility properties to standard hypertext markup language (HTML) elements specified in the source data.

In an example embodiment, an apparatus for performing the method of FIG. 7 above may comprise a processor (e.g., the processor 70) configured to perform some or each of the operations (500-530) described above. The processor may, for example, be configured to perform the operations (500-530) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 500-530 may comprise, for example, the processor 70, the user interface manager 80, and/or a device or circuit for executing instructions or executing an algorithm for processing information as described above.

In some cases, the operations (500-530) described above, along with any of the modifications may be implemented in a method that involves facilitating access to at least one interface to allow access to at least one service via at least one network. In such cases, the at least one service may be to perform at least operations 500-530.

An example of an apparatus according to an example embodiment may include at least one processor and at least one memory including computer program code. The at least one memory and the computer program code may be configured to, with the at least one processor, cause the apparatus to perform the operations 500-530 (with or without the modifications and amplifications described above in any combination).

An example of a computer program product according to an example embodiment may include at least one computer-readable storage medium having computer-executable program code portions stored therein. The computer-executable program code portions may include program code instructions for performing operation 500-530 (with or without the modifications and amplifications described above in any combination).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
receive source data comprising one or more web pages with corresponding web content;
receive an indication of a visual rendering parameter for application to a user interface element of the source data during rendering of a native application user interface element corresponding to the user interface element of the source data; and
cause visual rendering of the native application user interface element based on the visual rendering parameter.

2. The apparatus of claim 1, wherein the memory and computer program code are configured to, with the processor, cause the apparatus to receive source data including receiving web content having user interface elements generated via hypertext markup language (HTML), cascading style sheet (CSS) or JavaScript.

3. The apparatus of claim 1, wherein the memory and computer program code are further configured to, with the processor, cause the apparatus to enable user interaction with the corresponding native application user interface element.

4. The apparatus of claim 1, wherein the memory and computer program code are configured to, with the processor, cause the apparatus to receive the indication of the visual rendering parameter by receiving placement markup defining a modification for placement, visibility, scaling, or style properties of the native application user interface element.

5. The apparatus of claim 4, wherein the memory and computer program code are configured to, with the processor, cause the apparatus to receive placement markup by receiving placement markup specified directly in the source data.

6. The apparatus of claim 4, wherein the memory and computer program code are configured to, with the processor, cause the apparatus to receive placement markup by receiving placement markup specified by adding non-standard cascading style sheet (CSS) style rules.

7. The apparatus of claim 4, wherein the memory and computer program code are configured to, with the processor, cause the apparatus to receive placement markup by receiving placement markup specified by providing a JavaScript class that controls user interface element placement.

8. The apparatus of claim 4, wherein the memory and computer program code are configured to, with the processor, cause the apparatus to receive placement markup by receiving placement markup specified in a separate document that uses non-standard markup to apply placement and visibility properties to standard hypertext markup language (HTML) elements specified in the source data

9. The apparatus of claim 1, wherein the apparatus is a mobile terminal and further comprises user interface circuitry configured to facilitate user control of at least some functions of the mobile terminal.

10. A method comprising:
receiving source data comprising one or more web pages with corresponding web content;
receiving an indication of a visual rendering parameter for application to a user interface element of the source data during rendering of a native application user interface element corresponding to the user interface element of the source data; and
causing, via a processor, visual rendering of the native application user interface element based on the visual rendering parameter.

11. The method of claim 10, wherein receiving source data comprises receiving web content having user interface elements generated via hypertext markup language (HTML), cascading style sheet (CSS) or JavaScript.

12. The method of claim 10, further comprising enabling user interaction with the corresponding native application user interface element.

13. The method of claim 10, wherein receiving the indication of the visual rendering parameter comprises receiving placement markup defining a modification for placement, visibility, scaling, or style properties of the native application user interface element.

14. The method of claim 13, wherein receiving placement markup comprises receiving placement markup specified directly in the source data.

15. The method of claim 13, wherein receiving placement markup comprises receiving placement markup specified by adding non-standard cascading style sheet (CSS) style rules.

16. The method of claim 13, wherein receiving placement markup comprises receiving placement markup specified by providing a JavaScript class that controls user interface element placement.

17. The method of claim 13, wherein receiving placement markup comprises receiving placement markup specified in a separate document that uses non-standard markup to apply placement and visibility properties to standard hypertext markup language (HTML) elements specified in the source data.

18. A computer program product comprising at least one computer-readable storage medium having computer-executable program code portions stored therein, the computer-executable program code portions comprising program code instructions for:
receiving source data comprising one or more web pages with corresponding web content;
receiving an indication of a visual rendering parameter for application to a user interface element of the source data during rendering of a native application user interface element corresponding to the user interface element of the source data; and
causing visual rendering of the native application user interface element based on the visual rendering parameter.

19. The computer program product of claim 18, wherein program code instructions for receiving the indication of the visual rendering parameter include instructions for receiving placement markup defining a modification for placement, visibility, scaling, or style properties of the native application user interface element.

20. The computer program product of claim 18, wherein program code instructions for receiving placement markup include instructions for receiving placement markup specified directly in the source data, receiving placement markup specified by adding non-standard cascading style sheet (CSS) style rules, receiving placement markup specified by providing a JavaScript class that controls user interface element placement, or receiving placement markup specified in a separate document that uses non-standard markup to apply placement and visibility properties to standard hypertext markup language (HTML) elements specified in the source data.
